(19) United States
(12) Patent Application Publication
(10) Pub. No.: US 2020/0250460 A1
(43) Pub. Date: Aug. 6, 2020

(54) HEAD REGION RECOGNITION METHOD AND APPARATUS, AND DEVICE

(71) Applicant: Tencent Technology (Shenzhen) Company Limited, Shenzhen (CN)

(72) Inventors: Ji WANG, Shenzhen (CN); Zhibo CHEN, Shenzhen (CN); Yunlu XU, Shenzhen (CN); Bing YAN, Shenzhen (CN)

(21) Appl. No.: 16/857,613

(22) Filed: Apr. 24, 2020

Related U.S. Application Data
(63) Continuation of application No. PCT/CN2018/116036, filed on Nov. 16, 2018.

(30) Foreign Application Priority Data
Dec. 8, 2017 (CN) 201711295898.X

(51) Int. Cl. G06K 9/46; G06N 3/08; G06K 9/00; G06K 9/62

(52) U.S. Cl. CPC G06K 9/4609; G06K 9/6256; G06K 9/00241; G06N 3/08

(57) ABSTRACT

This application discloses a head region recognition method performed at a computing device. The method includes: acquiring an input image; processing the input image using n cascaded neural network layers to obtain n sets of candidate recognition results of a head region, each of the n neural network layers outputting one respective set of candidate recognition results, the neural network layer being used for recognizing the head region according to a preset extraction box, sizes of extraction boxes used by at least two of the neural network layers being different, and n being a positive integer and n≥2; and aggregating the n sets of candidate recognition results to obtain a final recognition result of the head region in the input image. Therefore, head regions with different sizes in the input image can be recognized, thereby improving recognition accuracy.

### RELATED APPLICATION

This application is a continuation application of PCT Application No. PCT/CN2018/116036, entitled “HUMAN HEAD REGION RECOGNITION METHOD, DEVICE AND APPARATUS” filed on Nov. 16, 2018, which claims priority to Chinese Patent Application No. 201711295898.X, entitled “HEAD REGION RECOGNITION METHOD AND APPARATUS, AND DEVICE” filed with the China National Intellectual Property Administration on Dec. 8, 2017, all of which are incorporated by reference in their entirety.

### FIELD OF THE TECHNOLOGY

This application relates to the field of machine learning, and in particular, to a head region recognition method and apparatus, and a device.

### BACKGROUND OF THE DISCLOSURE

Head recognition is a key technology in the surveillance field in public places. Currently, head recognition is mainly implemented through a machine learning model such as a neural network model.

In the related art, a head region in a surveillance image may be recognized by using the machine learning model. This process includes: performing surveillance on a densely populated region such as an elevator, a gate, or an intersection to obtain a to-be-detected image, and inputting the to-be-detected image into a neural network model; and recognizing an image feature based on an extraction box with a fixed size by using the neural network model, and outputting an analysis result when the image feature meets a facial feature.

Because the head region is recognized based on the extraction box with a fixed size, a face cannot be recognized by using the foregoing method when the face occupies a relatively small area in the surveillance image, which results in missed recognition, thereby resulting in low recognition accuracy.

### SUMMARY

Embodiments of this application provide a head region recognition method and apparatus, and a device, to resolve a problem that a face cannot be recognized in the related art when the face occupies a relatively small area in a surveillance image. The technical solutions are as follows:

According to one aspect, an embodiment of this application provides a head region recognition method performed by a computing device, the method including:

acquiring an input image;

processing the input image using n cascaded neural network layers to obtain n sets of candidate recognition results of a head region, each of the n neural network layers outputting one respective set of candidate recognition results, the neural network layer being used for recognizing the head region according to a preset extraction box, sizes of extraction boxes used by at least two of the neural network layers being different, and n being a positive integer and n≥2; and

aggregating the n sets of candidate recognition results to obtain a final recognition result of the head region in the input image.

According to another aspect, an embodiment of this application provides a computing device having one or more processors and memory, the memory storing one or more programs, the one or more programs being configured to be executed by the one or more processors and comprising an instruction for performing the foregoing head region recognition method.

According to yet another aspect, an embodiment of this application provides a non-transitory computer readable storage medium, storing at least one instruction, the instruction being loaded and executed by a computing device having one or more processors to perform the foregoing head region recognition method.

Beneficial effects brought by the technical solutions provided in the embodiments of this application are at least as follows:

An image is input into n cascaded neural network layers to obtain n sets of candidate recognition results, and the n sets of candidate recognition results are aggregated to obtain a final recognition result of a head region in the input image. Sizes of extraction boxes used by at least two of the n neural network layers are different. Therefore, a problem that the head region cannot be recognized based on an extraction box with a fixed size when a face occupies a relatively small in a surveillance image is resolved, and head regions with different sizes in the input image can be recognized, thereby improving recognition accuracy.

### BRIEF DESCRIPTION OF THE DRAWINGS

To describe the technical solutions in the embodiments of this application more clearly, the following briefly describes the accompanying drawings required for describing the embodiments. Apparently, the accompanying drawings in the following description show merely some embodiments of this application, and a person of ordinary skill in the art may still derive other drawings from these accompanying drawings without creative efforts.

FIG. 1 is a schematic diagram of an implementation environment of a head region recognition method according to an exemplary embodiment of this application.

FIG. 2 is a method flowchart of a head region recognition method according to an exemplary embodiment of this application.

FIG. 3 is a flowchart of outputting a final recognition result after an input image is recognized through a neural network according to an exemplary embodiment of this application.

FIG. 4 is a method flowchart of a head region recognition method according to another exemplary embodiment of this application.

FIG. 5 is a schematic diagram of an output image obtained after a plurality of candidate recognition results are superimposed according to an exemplary embodiment of this application.

FIG. 6 is a schematic diagram of an output image obtained after a plurality of candidate recognition results are combined according to an exemplary embodiment of this application.

FIG. 7 is a method flowchart of a head region recognition method according to another exemplary embodiment of this application.

FIG. 8 is a block diagram of steps of a head region recognition method according to an exemplary embodiment of this application.

FIG. 9 is a method flowchart of a pedestrian flow surveillance method according to an exemplary embodiment of this application.

FIG. 10 is a block diagram of a head region recognition apparatus according to an exemplary embodiment of this application.

FIG. 11 is a block diagram of a recognition device according to an exemplary embodiment of this application.

### DESCRIPTION OF EMBODIMENTS

To make objectives, technical solutions, and advantages of this application clearer, the following further describes in detail implementations of this application with reference to the accompanying drawings.

A neural network is an operational model including a large number of nodes (or referred to as neurons) connected to each other, each node corresponding to one policy function. A connection between each two nodes represents a weighted value of a signal passing through the connection, the weighted value being referred to as a weight. Cascaded neural network layers include a plurality of neural network layers, output of an i^{th} neural network layer being connected to input of an (i+1)^{th} neural network layer, output of the (i+1)^{th} neural network layer being connected to an (i+2)^{th} neural network layer, and by analogy. Each neural network layer includes at least one node. After a sample is input to the cascaded neural network layers, an output result is output by each neural network layer, and the output result is used as an input sample for a next neural network layer. The cascaded neural network layers adjust a policy function and a weight value of each node in each neural network layer based on a final output result of the sample. This process is referred to as training.

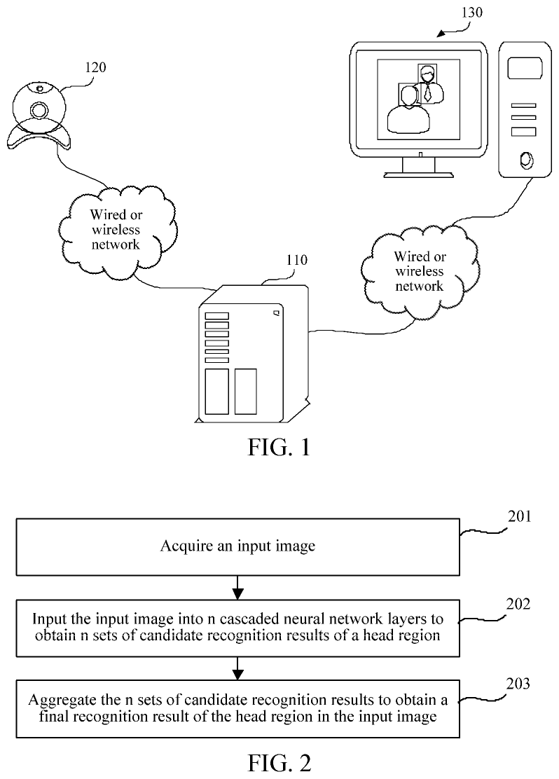

FIG. 1 is a schematic diagram of an implementation environment of a head region recognition method according to an exemplary embodiment of this application. As shown in FIG. 1, the implementation environment includes: a surveillance camera 110, a server 120, and a terminal 130, the surveillance camera 110 establishing a communication connection with the server 120 through a wired or wireless network, and the terminal 130 establishing a communication connection with the server 120 through a wired or wireless network.

The surveillance camera 110 is configured to capture a surveillance image of a surveillance region and transmit the surveillance image to the server 120 as an input image.

The server 120 is configured to input the input image into n cascaded neural network layers by using the image transmitted by the surveillance camera 110 as the input image, each of the neural network layers outputting one set of candidate recognition results, the candidate recognition results output by each of the neural network layers being summarized to obtain n sets of candidate recognition results of a head region, the neural network layer being used for recognizing the head region according to a preset extraction box, sizes of extraction boxes used by at least two of the neural network layers being different, and n being a positive integer and n≥2; and aggregate the n sets of candidate recognition results to obtain a final recognition result of the head region in the input image, and transmit a final output result to the terminal.

The terminal 130 is configured to receive and display the final output result transmitted by the server 120. In different embodiments, the server 120 and the terminal 130 may be integrated into one device.

Optionally, the final output result may be a result of recognizing a target head or recognizing a region including a head in the input image.

FIG. 2 is a method flowchart of a head region recognition method according to an exemplary embodiment of this application. The method is applied to a recognition device. The recognition device may be the server 120 shown in FIG. 1, or may be a device in which the server 120 and the terminal 130 are integrated. The method includes the following steps:

Step 201: Acquire an input image.

The recognition device acquires the input image. The input image may be an image frame transmitted by a surveillance camera through a wired or wireless network, or in other manners, such as copying a local image file in the recognition device, or may be an image transmitted by another apparatus through a wired or wireless network.

Step 202: Input the input image into n cascaded neural network layers to obtain n sets of candidate recognition results of a head region.

The recognition device inputs the input image into the n cascaded neural network layers to obtain the candidate recognition results. Sizes of extraction boxes used by at least two of the n neural network layers are different, each neural network layer extracting a feature of each-layer feature map through an extraction box corresponding to the layer, and n being a positive integer and n≥2.

The extraction box defines a size of the extraction box of each neural network layer, and each neural network layer extracts the feature based on the size of the extraction box. For example, pixels of the input image is 300×300, and pixels of a feature layer output after a feature is extracted from a neural network layer with an extraction box of 200×200 pixels are 200×200.

Optionally, the recognition device inputs the input image into a first neural network layer in the n neural network layers to obtain a first-layer feature map and a first set of candidate recognition results; and inputs an i^{th}-layer feature map into an (i+1)^{th} neural network layer in the n neural network layers to obtain an (i+1)^{th}-layer feature map and an (i+1)^{th} set of candidate recognition results, i being a positive integer and 1≤i≤n−1.

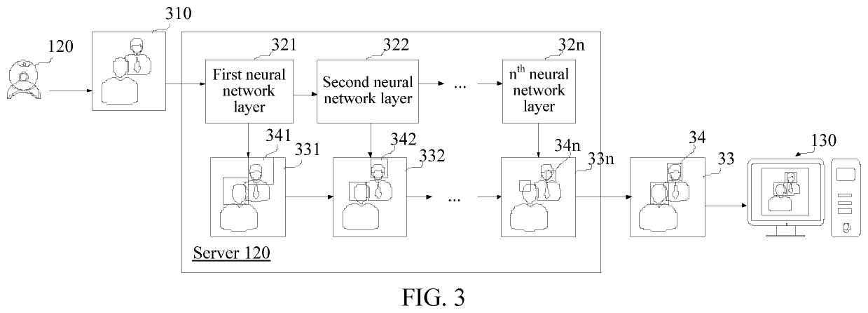

For example, as shown in FIG. 3, the server 120 obtains an input image 310 and inputs the input image 310 to a first neural network layer 321 in the server 120. The first neural network layer extracts a feature of the image 310 through a first extraction box to obtain a first-layer feature map, outputs a first set of candidate recognition results 331, and uses a first recognition box 341 to mark a location of a head region in the first set of candidate recognition results 331, a recognition box being an identifier for marking the location of the head region, and each recognition box corresponding to one location and a similarity value. A second neural network layer extracts a feature of the first-layer feature map through a second extraction box, outputs a second-layer feature map and a second set of candidate recognition results 332, and uses a second recognition box 342 to mark a location and a similarity value of the head region in the second set of candidate recognition results 332. By analogy, an i^{th} neural network layer extracts an (i−1)^{th}-layer feature map through an i^{th} extraction box (an i^{th}-layer feature map is the input image when i=1), outputs the i^{th}-layer feature map and an i^{th} set of candidate recognition results, and uses an i^{th} recognition box to mark a location of the head region and a candidate recognition result corresponding to each recognition box. Finally, an n^{th} neural network layer extracts an (n−1)^{th}-layer feature map through an n^{th} extraction box, outputs an n^{th}-layer feature map and an n^{th} set of candidate recognition results 33n, and uses an n^{th} recognition box 34n to mark a location and a similarity value of the head region in the n^{th} set of candidate recognition results.

Sizes of at least two of n extraction boxes are different. Optionally, a size of an extraction box corresponding to each neural network layer varies. A size of the i^{th} extraction box used by the i^{th} neural network layer in the n neural network layers is greater than a size of an (i+1)^{th} extraction box used by an (i+1)^{th} neural network layer.

Optionally, each neural network layer outputs one set of candidate recognition results, each set of candidate recognition results including no recognition box or recognition boxes of a plurality of head regions. Because the same head region may be recognized by extraction boxes of different sizes, there may be recognition boxes with the same location or similar locations in different candidate recognition results.

Step 203: Aggregate then sets of candidate recognition results to obtain a final recognition result of the head region in the input image.

The recognition device aggregates the n sets of candidate recognition results to obtain the final recognition result of the head region in the input image.

For example, as shown in FIG. 3, the server 120 combines the n sets of candidate recognition results 331, 332, . . . , and 33n to obtain a final recognition result 33, and marks the head region by using a combined recognition box 34.

Optionally, the recognition device combines, into the same combined recognition box, recognition boxes with location similarities greater than a preset threshold in the n sets of candidate recognition results, and uses the combined recognition box as the final recognition result of the head region in the input image.

Optionally, the recognition device acquires similarity values corresponding to the recognition boxes with the location similarities greater than the preset threshold; retains a recognition box with a largest similarity value and deletes other recognition boxes in the recognition boxes with the location similarities greater than the preset threshold; and uses the retained recognition box as the final recognition result of the head region in the input image.

Because there may be recognition boxes with the same location or similar locations in different candidate recognition results, a candidate recognition result with a largest similarity value in the recognition boxes with the same location or similar locations is retained, and a recognition box with a smaller similarity value is deleted, so that redundant recognition boxes can be removed and an output image is clearer.

In view of the above, in this embodiment of this application, an image is input into n cascaded neural network layers to obtain n sets of candidate recognition results, and the n sets of candidate recognition results are aggregated to obtain a final recognition result of a head region in the input image. Sizes of extraction boxes used by at least two of the n neural network layers are different. Therefore, a problem that the head region cannot be recognized based on an extraction box with a fixed size when a face occupies a relatively small area in a surveillance image is resolved, and head regions with different sizes in the input image can be recognized, thereby improving recognition accuracy.

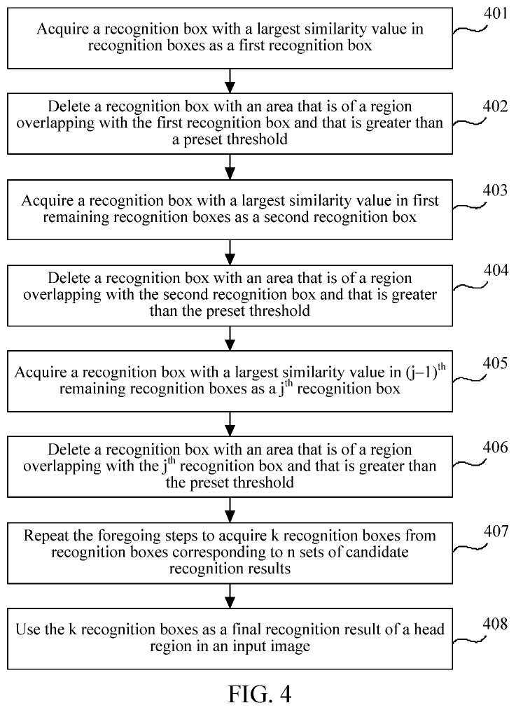

FIG. 4 is a method flowchart of a head region recognition method according to another exemplary embodiment of this application. The method is applied to a recognition device. The recognition device may be the server 120 shown in FIG. 1, or may be a device in which the server 120 and the terminal 130 are integrated. This method is an optional implementation of step 203 shown in FIG. 2, and is applicable to the embodiment shown in FIG. 2. The method includes the following steps:

Step 401: Acquire a recognition box with a largest similarity value in recognition boxes as a first recognition box.

The recognition device acquires a recognition box with a largest similarity value in recognition boxes corresponding to the n sets of candidate recognition results.

The same head region may correspond to a plurality of recognition boxes, and the plurality of recognition boxes need to be combined into one recognition box to avoid redundancy.

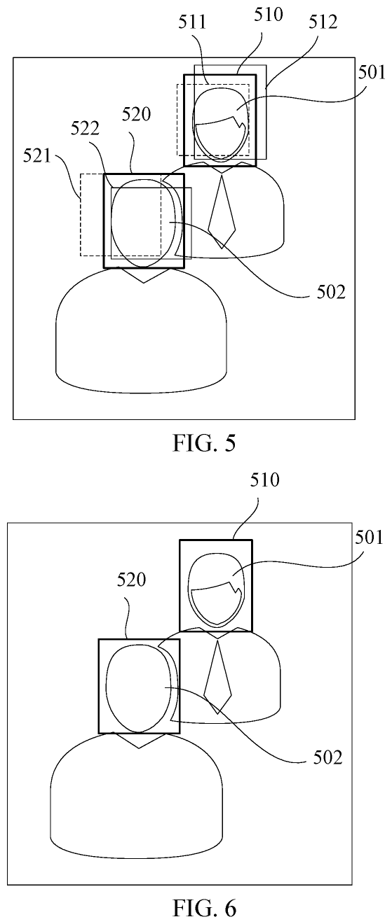

For example, the recognition result superimposed by a plurality of sets of candidate recognition results shown in FIG. 5 includes six recognition boxes. The same head region 501 corresponds to three candidate recognition results, which are respectively marked with recognition boxes 510, 511, and 512.

Each recognition box corresponds to one recognition result in each set of candidate recognition results. For example, as shown in FIG. 5, a similarity value corresponding to the recognition box 510 is 95%, and a corresponding recognition result is (Head: 95%; x₁, y₁, w₁, h₁); a similarity value corresponding to the recognition box 511 is 80%, and a corresponding recognition result is (Head: 80%; x₂, y₂, w₂, h₂); a similarity value corresponding to the recognition box 512 is 70%, and a corresponding recognition result is (Head: 70%; x₃, y₃, w₃, h₃); a similarity value corresponding to the recognition box 520 is 92%, and a corresponding recognition result is (Head: 92%; x₄, y₄, W₄, h₄); a similarity value corresponding to the recognition box 521 is 50%, and a corresponding recognition result is (Head: 50%; x₅, y₅, w₅, h₅); a similarity value corresponding to the recognition box 522 is 70%, and a corresponding recognition result is (Head: 70%; x₆, y₆, w₆, h₆). A recognition result corresponding to each recognition box includes a category (for example, a head), coordinate values (x and y) of a reference point, a width value (w) of the recognition box, and a height value (h) of the recognition box. The reference point is a preset pixel of the recognition box, and may be a center of the recognition box, or a vertex of any one of four inner angles of the recognition box. The width of the recognition box is a side length value along a y-axis direction, and the height of the recognition box is a side length value along an x-axis direction. The coordinates of the reference point, the width of the recognition box, and the height of the recognition box define a location of the recognition box.

The recognition device acquires the recognition box with the highest similarity value in the plurality of sets of candidate recognition results as the first recognition box, namely, the recognition box 510 in FIG. 5.

Step 402: Delete a recognition box with an area that is of a region overlapping with the first recognition box and that is greater than a preset threshold.

The recognition device deletes the recognition box with the area that overlaps with the area of the first recognition box and that is greater than the preset threshold.

For example, as shown in FIG. 5, a candidate recognition result corresponding to the recognition box 510 is a first maximum recognition result, a percentage of an overlapping area between the recognition box 511 and the recognition box 510 is 80%, a percentage of an overlapping area between the recognition box 512 and the recognition box 510 is 65%, and a percentage of an overlapping area between the recognition box 520, the recognition box 521, and the recognition box 522 and the recognition box 510 is 0%. If the preset threshold is 50%, the recognition box 511 and the recognition box 512 greater than the preset threshold are deleted.

Step 403: Acquire a recognition box with a largest similarity value in first remaining recognition boxes as a second recognition box.

The recognition device uses remaining recognition boxes as the first remaining recognition boxes, and acquires the recognition box with the largest similarity value in the first remaining recognition boxes as the second recognition box after acquiring the first recognition box and deleting the recognition box with the area that overlaps with the area of the first recognition box and that is greater than the preset threshold.

For example, as shown in FIG. 5, after obtaining the first recognition box, namely, the recognition box 510, the recognition device uses remaining recognition boxes 520, 521, and 522 as the first remaining recognition boxes, and uses the recognition box 520 with the largest similarity value in the first remaining recognition boxes as the second recognition box.

Step 404: Delete a recognition box with an area that is of a region overlapping with the second recognition box and that is greater than the preset threshold.

The recognition device deletes the recognition box with the area that overlaps with the area of the second recognition box and that is greater than the preset threshold.

For example, as shown in FIG. 5, a candidate recognition result corresponding to the recognition box 520 is a second maximum recognition result, a percentage of an overlapping area between the recognition box 521 and the recognition box 520 is 55%, and a percentage of an overlapping area between the recognition box 522 and the recognition box 520 is 70%. If the preset threshold is 50%, the recognition box 521 and recognition box 522 greater than the preset threshold are deleted.

Step 405: Acquire a recognition box with a largest similarity value in (j−1)^{th} remaining recognition boxes as a i^{th} recognition box.

Based on the foregoing step, the recognition device uses remaining recognition boxes as the (j−1)^{th} remaining recognition boxes and acquires the recognition box with the largest similarity value in the (j−1)^{th} remaining recognition boxes as the j^{th} recognition box after acquiring a (j−1)^{th} recognition box and deleting a recognition box with an area that is of a region overlapping with the (j−1)^{th} recognition box and that is greater than the preset threshold, j being a positive integer and 2≤j≤n.

Step 406: Delete a recognition box with an area that is of a region overlapping with the j^{th} recognition box and that is greater than the preset threshold.

The recognition device deletes the recognition box with the area that overlaps with the area of the i^{th} recognition box and that is greater than the preset threshold.

Step 407: Repeat the foregoing steps to acquire k recognition boxes from recognition boxes corresponding to n sets of candidate recognition results.

The recognition device repeats the foregoing steps until the k recognition boxes ate acquired from the recognition boxes corresponding to the n sets of candidate recognition results, overlapping areas of the remaining k recognition boxes being all less than the preset threshold, and k being a positive integer and 2≤k≤n.

Step 408: Use the k recognition boxes as a final recognition result of a head region in an input image.

The recognition device uses the remaining k recognition boxes as the final recognition result of the head region in the input image.

For example, as shown in FIG. 6, the recognition boxes 510 and 520 are the final recognition result after the recognition boxes 511, 512, 521, and 522 are deleted.

In view of the above, in this embodiment of this application, recognition boxes with location similarities greater than the preset threshold in the n sets of candidate recognition results are combined into one recognition box, and the combined recognition box is used as the final recognition result of the head region in the input image. In this way, a problem that the same head recognition region corresponds to a plurality of recognition results in the final recognition result is resolved, thereby improving recognition accuracy.

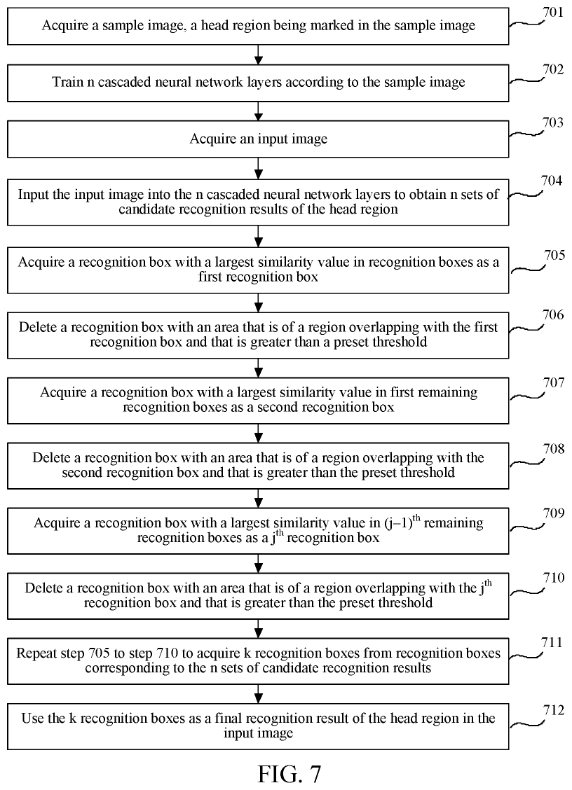

FIG. 7 is a method flowchart of a head region recognition method according to another exemplary embodiment of this application. The method is applied to a recognition device. The recognition device may be the server 120 shown in FIG. 1, or may be a device in which the server 120 and the terminal 130 are integrated. The method includes the following steps:

Step 701: Acquire a sample image, a head region being marked in the sample image.

A neural network needs to be trained before an input image is recognized. The recognition device acquires the sample image, the head region being marked in the sample image and including at least one of a side-view head region, a top-view head region, a rear-view head region, and a covered head region.

Step 702: Train n cascaded neural network layers according to the sample image.

The recognition device trains the n cascaded neural network layers according to the sample image, n being a positive integer and n≥2.

In the related art, for recognition of a head region, a training method of a neural network is to input a sample image marked with a face into the neural network for training. Usually, a face region is blocked in a surveillance image, and sometimes the face does not appear but there is only a head region viewed from another direction such as the back of a head or the top of the head in the image. Therefore, a head region that is not the face in the input image cannot be accurately recognized in the neural network trained by using only the sample image marked with the face.

For this technical problem, in this embodiment of this application, the neural network is trained by using the sample image in which the at least one of the side-view head region, the top-view head region, the rear-view head region, and the covered head region is marked. In this way, a problem that a head region that is not a face in the input image cannot be accurately recognized in the neural network trained by using only the sample image marked with the face is resolved, thereby improving recognition accuracy.

Optionally, a training method may be an error back propagation algorithm. A method for training the neural network by using the error back propagation algorithm includes but is not limited to: inputting, by the recognition device, the sample image into the n cascaded neural network layers to obtain a training result; comparing the training result with the marked head region in the sample image to obtain a calculation loss, the calculation loss being used for indicating an error between the training result and the marked head region in the sample image; and training the n cascaded neural network layers by using an error back propagation algorithm according to the calculation loss corresponding to the sample image.

The recognition device in step 701 and step 702 may be a special training device, and is not the same device as the recognition device that performs step 703 to step 712. After the training device obtains the training result by performing step 701 and step 702, the recognition device performs step 703 to step 712 based on the training result. Alternatively, the recognition device that performs step 701 and step 702 may be the recognition device that performs step 703 to step 712. The training step in step 701 and step 702 may be pre-trained or a part of pre-training. Training in steps 701 and 702 is performed when step 703 to step 712 are performed, and an execution order of step 701, step 702, and subsequent steps is not limited.

Step 703: Acquire an input image.

For a method for acquiring the input image by the recognition device, reference is made to the related description of step 201 in the embodiment of FIG. 2, and the details are not described herein again.

Step 704: Input the input image into the n cascaded neural network layers to obtain n sets of candidate recognition results of the head region.

The recognition device inputs the input image into the n cascaded neural network layers to obtain the candidate recognition results. Sizes of extraction boxes used by at least two of the n neural network layers are different, each neural network layer extracting a feature of each-layer feature map through an extraction box corresponding to the layer.

Sizes of at least two of n extraction boxes are different. Optionally, a size of an extraction box corresponding to each neural network layer varies. A size of an i^{th} extraction box used by an i^{th} neural network layer in the n neural network layers is greater than a size of an (i+1)^{th} extraction box used by an (i+1)^{th} neural network layer, n being a positive integer and 1≤i≤n−1.

For a method for obtaining the n sets of candidate recognition results by the recognition device by using the n cascaded neural network layers, reference is made to the related description of step 202 in the embodiment of FIG. 2, and the details are not described herein again.

Step 705: Acquire a recognition box with a largest similarity value in recognition boxes as a first recognition box.

The recognition device acquires a recognition box with a largest similarity value in recognition boxes corresponding to the n sets of candidate recognition results.

The same head region may correspond to a plurality of candidate results, and the plurality of candidate results need to be combined into the same candidate result to avoid redundancy.

Step 706: Delete a recognition box with an area that is of a region overlapping with the first recognition box and that is greater than a preset threshold.

The recognition device deletes the recognition box with the area that overlaps with the area of the first recognition box and that is greater than the preset threshold.

Step 707: Acquire a recognition box with a largest similarity value in first remaining recognition boxes as a second recognition box.

The recognition device uses remaining recognition boxes as the first remaining recognition boxes, and acquires the recognition box with the largest similarity value in the first remaining recognition boxes as the second recognition box after acquiring the first recognition box and deleting the recognition box with the area that overlaps with the area of the first recognition box and that is greater than the preset threshold.

Step 708: Delete a recognition box with an area that is of a region overlapping with the second recognition box and that is greater than the preset threshold.

The recognition device deletes the recognition box with the area that overlaps with the area of the second recognition box and that is greater than the preset threshold.

Step 709: Acquire a recognition box with a largest similarity value in (j−1)^{th} remaining recognition boxes as a i^{th} recognition box.

Based on the foregoing step, remaining recognition boxes are used as the (j−1)^{th} remaining recognition boxes and the recognition box with the largest similarity value in the (j−1)^{th} remaining recognition boxes is acquired as the i^{th} recognition box after a (j−1)^{th} recognition box is acquired and a recognition box with an area that is of a region overlapping with the (j−1)^{th} recognition box and that is greater than the preset threshold is deleted, j being a positive integer and 2≤j≤n.

Step 710: Delete a recognition box with an area that is of a region overlapping with the j^{th} recognition box and that is greater than the preset threshold.

The recognition device deletes the recognition box with the area that overlaps with the area of the i^{th} recognition box and that is greater than the preset threshold.

Step 711: Repeat step 705 to step 710 to acquire k recognition boxes from recognition boxes corresponding to the n sets of candidate recognition results.

The recognition device repeats step 705 to step 710 until the k recognition boxes ate acquired from the recognition boxes corresponding to the n sets of candidate recognition results, overlapping areas of the remaining k recognition boxes being all less than the preset threshold, and k being a positive integer and 2≤k≤n.

Step 712: Use the k recognition boxes as a final recognition result of the head region in the input image.

The recognition device uses the remaining k recognition boxes as the final recognition result of the head region in the input image.

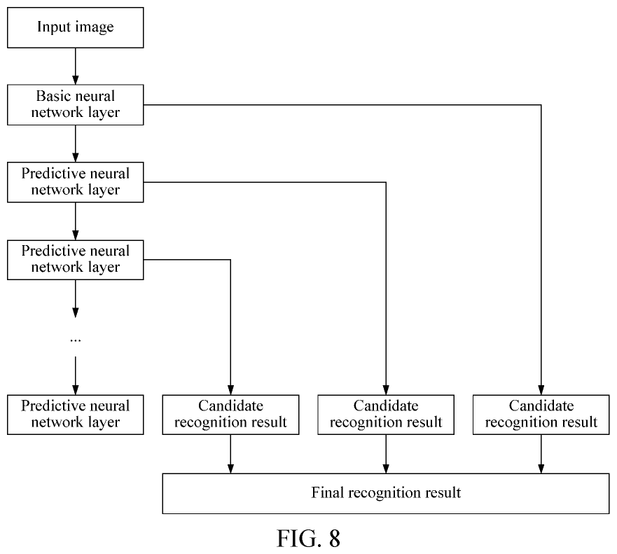

For example, FIG. 8 is a block diagram of steps of a head region recognition method according to an exemplary embodiment of this application. As shown in the figure, feature layers and candidate recognition results are output after an input image is input into a basic neural network. The candidate recognition results are output step by step through a subsequent predictive neural network, and are aggregated to obtain a final recognition result. A basic neural network layer is a neural network layer having an extraction box with a large size, and sizes of extraction boxes of a prediction neural network layer are gradually reduced.

In view of the above, in this embodiment of this application, an image is input into n cascaded neural network layers to obtain n sets of candidate recognition results, and the n sets of candidate recognition results are aggregated to obtain a final recognition result of a head region in the input image. Sizes of extraction boxes used by at least two of the n neural network layers are different. Therefore, a problem that the head region cannot be recognized based on an extraction box with a fixed size when a face occupies a relatively small area in a surveillance image is resolved, and head regions with different sizes in the input image can be recognized, thereby improving recognition accuracy.

Optionally, in this embodiment of this application, the neural network is trained by using the sample image in which the at least one of the side-view head region, the top-view head region, the rear-view head region, and the covered head region is marked. In this way, a problem that a head region that is not a face in the input image cannot be accurately recognized in the neural network trained by using only the sample image marked with the face is resolved, thereby improving recognition accuracy.

Optionally, in this embodiment of this application, recognition boxes with location similarities greater than the preset threshold in the n sets of candidate recognition results are combined into one recognition box, and the combined recognition box is used as the final recognition result of the head region in the input image. In this way, a problem that the same head recognition region corresponds to a plurality of recognition results in the final recognition result is resolved, thereby improving recognition accuracy.

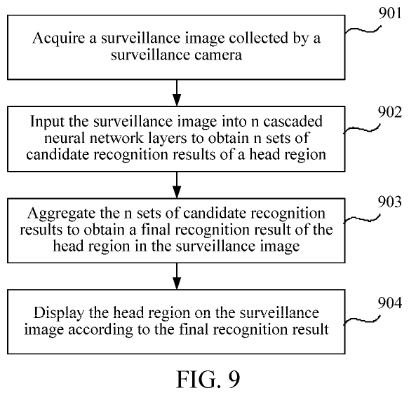

FIG. 9 is a method flowchart of a pedestrian flow surveillance method according to an exemplary embodiment of this application. The method is applied to a surveillance device. The surveillance device may be the server 120 shown in FIG. 1. The method includes the following steps:

Step 901: Acquire a surveillance image collected by a surveillance camera.

The surveillance camera collects a surveillance image of a surveillance region, and sends the surveillance image to the surveillance device through a wired or wireless network. The surveillance device obtains the surveillance image collected by the surveillance camera. The surveillance region may be a densely populated region such as a railway station, a shopping mall, or a tourist attraction, or a confidential region such as a government department, a military base, or a court.

Step 902: Input the surveillance image into n cascaded neural network layers to obtain n sets of candidate recognition results of a head region.

The surveillance device inputs the surveillance image into the n cascaded neural network layers to obtain the candidate recognition results. Sizes of extraction boxes used by at least two of the n neural network layers are different, each neural network layer extracting a feature of each-layer feature map through an extraction box corresponding to the layer, and n being a positive integer and n≥2.

Optionally, the surveillance device performs local brightening and/or resolution reduction processing on the surveillance image before inputting the surveillance image into the n cascaded neural network layers; and inputting the surveillance image obtained after the local brightening and/or resolution reduction processing into the n cascaded neural network layers. The surveillance image obtained after the local brightening and/or resolution reduction processing can improve recognition efficiency and accuracy of a neural network layer.

Optionally, the surveillance device inputs the surveillance image into a first neural network layer in the n neural network layers to obtain a first-layer feature map and a first set of candidate recognition results; and inputs an i^{th}-layer feature map into an (i+1)^{th} neural network layer in the n neural network layers to obtain an (i+1)^{th}-layer feature map and an (i+1)^{th} set of candidate recognition results, i being a positive integer and 1≤i≤n−1.

Sizes of at least two of n extraction boxes are different. Optionally, a size of an extraction box corresponding to each neural network layer varies. A size of the i^{th} extraction box used by the i^{th} neural network layer in the n neural network layers is greater than a size of an (i+1)^{th} extraction box used by an (i+1)^{th} neural network layer.

Optionally, each neural network layer outputs one set of candidate recognition results, each set of candidate recognition results including no recognition box or recognition boxes of a plurality of head regions. Because the same head region may be recognized by extraction boxes of different sizes, there may be recognition boxes with the same location or similar locations in different candidate recognition results.

Optionally, the surveillance device needs to train the n cascaded neural network layers before recognizing the surveillance image. For the training method, reference is made to step 701 and step 702 in the embodiment of FIG. 7.

Step 903: Aggregate then sets of candidate recognition results to obtain a final recognition result of the head region in the surveillance image.

The surveillance device obtains the final recognition result of the head region in the surveillance image after aggregating the n sets of candidate recognition results.

Optionally, the surveillance device combines, into the same recognition result, extraction boxes with location similarities greater than a preset threshold in the n sets of candidate recognition results, to obtain the final recognition result of the head region in the surveillance image. Optionally, for a method for aggregating the n sets of candidate recognition results by the surveillance device to obtain the final recognition result of the head region in the surveillance image, reference is made to step 705 to step 712 in the embodiment of FIG. 7, and the details are not described herein again.

Step 904: Display the head region on the surveillance image according to the final recognition result.

The surveillance device displays the head region on the surveillance image according to the final recognition result. The recognized head region may be a head region in which a pedestrian flow is displayed in the surveillance image, or may be a specific target displayed in the surveillance image such as a head region of a suspect.

In view of the above, in this embodiment of this application, a surveillance image is input into n cascaded neural network layers to obtain n sets of candidate recognition results, and the n sets of candidate recognition results are aggregated to obtain a final recognition result of a head region in the surveillance image. Sizes of extraction boxes used by at least two of the n neural network layers are different. Therefore, a problem that the head region cannot be recognized based on an extraction box with a fixed size when a face occupies a relatively small area in a surveillance image is resolved, and head regions with different sizes in the surveillance image can be recognized, thereby improving recognition accuracy.

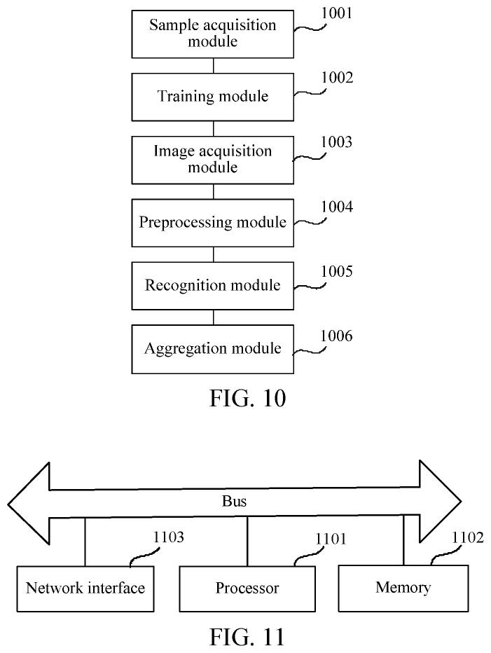

FIG. 10 is a block diagram of a head region recognition apparatus according to an exemplary embodiment of this application. The apparatus is applied to a recognition device. The recognition device may be the server 120 shown in FIG. 1, or may be a device in which the server 120 and the terminal 130 are integrated. The apparatus includes an image acquisition module 1003, a recognition module 1005, and an aggregation module 1006.

The image acquisition module 1003 is configured to acquire an input image.

The recognition module 1005 is configured to input the input image into n cascaded neural network layers to obtain n sets of candidate recognition results of a head region, n being a positive integer and n≥2.

The aggregation module 1006 is configured to aggregate the n sets of candidate recognition results to obtain a final recognition result of the head region in the input image.

In an optional embodiment, the recognition module 1005 is further configured to input the input image into a first neural network layer in the n neural network layers to obtain a first-layer feature map and a first set of candidate recognition results; and input an i^{th} layer feature map into an (i+1)^{th} neural network layer in the n neural network layers to obtain an (i+1)^{th}-layer feature map and an (i+1)^{th} set of candidate recognition results, i being a positive integer and 1≤i≤n−1, and a size of an i^{th} extraction box used by an i^{th} neural network layer in then neural network layers being greater than a size of an (i+1)^{th} extraction box used by the (i+1)^{th} neural network layer.

In an optional embodiment, each set of candidate recognition results include an extraction box of at least one head region, the extraction frame having a respective size.

The aggregation module 1006 is further configured to combine, into the same recognition result, candidate recognition results with location similarities greater than a preset threshold in the n sets of candidate recognition results, to obtain the final recognition result of the head region in the input image.

In an optional embodiment, the aggregation module 1006 is further configured to acquire similarity values corresponding to the candidate recognition results with the location similarities greater than the preset threshold in the n sets of candidate recognition results; retain a candidate recognition result with a largest similarity value and delete other candidate recognition results in the recognition results with the location similarities greater than the preset threshold; and use the retained candidate recognition result as the final recognition result of the head region in the input image.

In an optional embodiment, the aggregation module 1006 is further configured to acquire the candidate recognition result with the largest similarity value in the n sets of candidate recognition results as a first maximum recognition result; delete a candidate recognition result with an area that is of a region overlapping with the first maximum recognition result and that is greater than the preset threshold; acquire a candidate recognition result with a largest similarity value in first remaining recognition results as a second maximum recognition result; delete a candidate recognition result with an area that is of a region overlapping with the second maximum recognition result and that is greater than the preset threshold; acquire a candidate recognition result with a largest similarity value in (j−1)^{th} remaining recognition results as a i^{th} maximum recognition result, j being a positive integer and 2≤j≤n; delete a candidate recognition result with an area that is of a region overlapping with the j^{th} maximum recognition result and that is greater than the preset threshold; repeat the foregoing operations to acquire k maximum recognition results from the n sets of candidate recognition results, k being a positive integer and 2≤k≤n; and use the k maximum recognition results as the final recognition result of the head region in the input image.

In an optional embodiment, the head region recognition apparatus further includes a pre-processing module 1004.

The pre-processing module 1004 is configured to perform local brightening and/or resolution reduction processing on the input image; and input the input image obtained after the local brightening and/or resolution reduction processing into the n cascaded neural network layers.

In an optional embodiment, the head region recognition apparatus further includes a sample acquisition module 1001 and a training module 1002.

The sample acquisition module 1001 is configured to acquire a sample image, a head region being marked in the sample image and including at least one of a side-view head region, a top-view head region, a rear-view head region, and a covered head region.

The training module 1002 is configured to train the n cascaded neural network layers according to the sample image.

In an optional embodiment, the training module 1002 is further configured to input the sample image into the n cascaded neural network layers to obtain a training result; compare the training result with the marked head region in the sample image to obtain a calculation loss, the calculation loss being used for indicating an error between the training result and the marked head region in the sample image; and train the n cascaded neural network layers by using an error back propagation algorithm according to the calculation loss corresponding to the sample image.

In view of the above, in this embodiment of this application, the recognition module inputs an image into n cascaded neural network layers to obtain n sets of candidate recognition results, and the aggregation module aggregates the n sets of candidate recognition results to obtain a final recognition result of a head region in the input image. Sizes of extraction boxes used by at least two of the n neural network layers are different. Therefore, a problem that the head region cannot be recognized based on an extraction box with a fixed size when a face occupies a relatively small area in a surveillance image is resolved, thereby improving recognition accuracy.

Optionally, in this embodiment of this application, the training module trains the neural network by using the sample image in which the at least one of the side-view head region, the top-view head region, the rear-view head region, and the covered head region is marked. In this way, a problem that a head region that is not a face in the input image cannot be accurately recognized in the neural network trained by using only the sample image marked with the face is resolved, thereby improving recognition accuracy.

Optionally, in this embodiment of this application, the recognition module combines, into the same recognition result, the candidate recognition results with the location similarities greater than the preset threshold in the n sets of candidate recognition results, to obtain the final recognition result of the head region in the input image. In this way, a problem that the same head recognition region corresponds to a plurality of recognition results in the final recognition result is resolved, thereby improving recognition accuracy.

FIG. 11 is a block diagram of a recognition device according to an exemplary embodiment of this application. The recognition device includes a processor 1101, a memory 1102, and a network interface 1103.

The network interface 1103 is connected to the processor 1101 through a bus or other manners, and is configured to receive an input image or a sample image.

The processor 1101 may be a central processing unit (CPU), a network processor (NP), or a combination of the CPU and the NP. The processor 801 may further include a hardware chip. The hardware chip may be an application-specific integrated circuit (ASIC), a programmable logic device (PLD), or a combination thereof. The PLD may be a complex programmable logic device (CPLD), a field-programmable logic gate array (FPGA), a generic array logic (GAL), or any combination thereof. The processors 1101 may be one or more.

The memory 1102 is connected to the processor 1101 through a bus or other manners, the memory 1102 storing one or more programs. The one or more programs are executed by the processor 1101, and the one or more programs include execution of operation of the head region recognition method according to the embodiments shown in FIG. 2, FIG. 4, and FIG. 7; or execution of operation of the pedestrian flow surveillance method according to the embodiment shown in FIG. 9. The memory 1102 may be a volatile memory, a non-volatile memory, or a combination thereof. The volatile memory may be a random access memory (RAM), for example, a static random access memory (SRAM) or a dynamic random access memory (DRAM). The non-volatile memory may be a read-only memory (ROM), for example, a programmable read-only memory (PROM), an erasable programmable read-only memory (EPROM), or an electrically erasable programmable read-only memory (EEPROM). The non-volatile memory may alternatively be a flash memory or a magnetic memory, for example, a magnetic tape, a floppy disk, or a hard disk. The non-volatile memory may alternatively be an optical disc.

A computer-readable storage medium is further provided according to this application, the storage medium storing at least one instruction, at least one program, and a code set or an instruction set, and the at least one instruction, the at least one program, and the code set or the instruction set being loaded and executed by the processor to implement the head region recognition method or the pedestrian flow surveillance method according to the foregoing method embodiments.

Optionally, this application further provides a computer program product including an instruction. When the computer program product runs on a computer, the computer is caused to perform the head region recognition method or the pedestrian flow surveillance method according to the foregoing aspects.

It is to be understood that “plurality of” mentioned in the specification means two or more. The “and/or” describes an association relationship for describing associated objects and represents that three relationships may exist. For example, A and/or B may represent the following three cases: Only A exists, both A and B exist, and only B exists. The character “/” in this specification generally indicates an “or” relationship between the associated objects.

The sequence numbers of the foregoing embodiments of this application are merely for the convenience of description, and do not imply the preference among the embodiments.

A person of ordinary skill in the art may understand that all or some of steps of the embodiments may be implemented by hardware or a program instructing related hardware. The program may be stored in a computer-readable storage medium. The storage medium may be a read-only memory (ROM), a magnetic disk or an optical disc.

The foregoing descriptions are merely exemplary embodiments of this application, but are not intended to limit this application. Any modification, equivalent replacement, or improvement made within the spirit and principle of this application shall fall within the protection scope of this application.

What is claimed is:

1. A head region recognition method, performed by a computing device, the method comprising:
acquiring an input image;
processing the input image using n cascaded neural network layers to obtain n sets of candidate recognition results of a head region, each of then neural network layers outputting one respective set of candidate recognition results, the neural network layer being used for recognizing the head region according to a preset extraction box, sizes of extraction boxes used by at least two of the neural network layers being different, and n being a positive integer and n≥2; and
aggregating the n sets of candidate recognition results to obtain a final recognition result of the head region in the input image.

2. The method according to claim 1, wherein the processing the input image using n cascaded neural network layers to obtain n sets of candidate recognition results of a head region comprises:
inputting the input image into a first neural network layer in the n neural network layers to obtain a first-layer feature map and a first set of candidate recognition results; and
inputting an i^{th}-layer feature map into an (i+1)^{th} neural network layer in the n neural network layers to obtain an (i+1)^{th}-layer feature map and an (i+1)^{th} candidate recognition result, n being a positive integer and 1≤i≤n−1, and
a size of an i^{th} extraction box used by an i^{th} neural network layer in the n neural network layers being greater than a size of an (i+1)^{th} extraction box used by the (i+1)^{th} neural network layer.

3. The method according to claim 1, wherein each set of candidate recognition results has zero or more recognition boxes, each recognition box having a corresponding location; and
the aggregating the n sets of candidate recognition results to obtain a final recognition result of the head region in the input image comprises:
combining the recognition boxes with corresponding location similarities greater than a preset threshold in the n sets of candidate recognition results into one combined recognition box, and using the combined recognition box as the final recognition result of the head region in the input image.

4. The method according to claim 3, wherein each set of recognition boxes has corresponding similarity values, and the combining the recognition results with corresponding location similarities greater than a preset threshold in the n sets of candidate recognition results into one combined recognition box comprises:
acquiring similarity values corresponding to the recognition boxes with the corresponding location similarities greater than the preset threshold;
retaining a recognition box with a largest similarity value and deleting other recognition boxes in the recognition boxes with the corresponding location similarities greater than the preset threshold; and
using the retained recognition box as the final recognition result of the head region in the input image.

5. The method according to claim 4, wherein the retaining a recognition box with a largest similarity value and deleting other recognition boxes in the recognition boxes with the corresponding location similarities greater than the preset threshold comprises:
acquiring the recognition box with the largest similarity value in the recognition frames as a first recognition box;
deleting a recognition box with an area that is of a region overlapping with the first recognition box and that is greater than the preset threshold;
acquiring a recognition box with a largest similarity value among first remaining recognition boxes as a second recognition box, the first remaining recognition boxes being the remaining recognition boxes other than the first recognition box and the deleted recognition box of the recognition boxes corresponding to the n sets of candidate recognition results;
deleting a recognition box with an area that is of a region overlapping with the second recognition box and that is greater than the preset threshold;
acquiring a recognition box with a largest similarity value among (j−1)^{th} remaining recognition boxes as a j^{th} recognition box, the (j−1)^{th} remaining recognition boxes being the remaining recognition boxes other than the first recognition box to a (j−1)^{th} recognition box and the deleted recognition box of the recognition boxes corresponding to the n sets of candidate recognition results, and j being a positive integer and 2≤j≤n;
deleting a recognition box with an area that is of a region overlapping with the j^{th} recognition box and that is greater than the preset threshold;
repeating the foregoing operations to acquire k recognition boxes from the recognition boxes corresponding to the n sets of candidate recognition results, k being a positive integer and 2≤k≤n; and
the using the retained recognition box as the final recognition result of the head region in the input image comprising:
using the k recognition boxes as the final recognition result of the head region in the input image.

6. The method according to claim 1, wherein the processing the input image using n cascaded neural network layers comprises:
performing local brightening and/or resolution reduction on the input image; and
processing the input image obtained after the local brightening and/or resolution reduction using the n cascaded neural network layers.

7. The method according to claim 1, further comprising:
acquiring a sample image, a head region being marked in the sample image and comprising at least one of a side-view head region, a top-view head region, a rear-view head region, and a covered head region; and
training the n cascaded neural network layers according to the sample image.

8. The method according to claim 7, wherein the training the n cascaded neural network layers according to the sample image comprises:
processing the sample image using the n cascaded neural network layers to obtain a training result;
comparing the training result with the marked head region in the sample image to obtain a calculation loss, the calculation loss being used for indicating an error between the training result and the marked head region in the sample image; and
training the n cascaded neural network layers by using an error back propagation algorithm according to the calculation loss corresponding to the sample image.

9. A computing device, comprising:
one or more processors; and
memory,
the memory storing one or more programs, the one or more programs being configured to be executed by the one or more processors and comprising an instruction for performing operations including:
acquiring an input image;
processing the input image using n cascaded neural network layers to obtain n sets of candidate recognition results of a head region, each of then neural network layers outputting one respective set of candidate recognition results, the neural network layer being used for recognizing the head region according to a preset extraction box, sizes of extraction boxes used by at least two of the neural network layers being different, and n being a positive integer and n≥2; and
aggregating the n sets of candidate recognition results to obtain a final recognition result of the head region in the input image.

10. The computing device according to claim 9, wherein the processing the input image using n cascaded neural network layers to obtain n sets of candidate recognition results of a head region comprises:
inputting the input image into a first neural network layer in the n neural network layers to obtain a first-layer feature map and a first set of candidate recognition results; and
inputting an i^{th}-layer feature map into an (i+1)^{th} neural network layer in the n neural network layers to obtain an (i+1)^{th}-layer feature map and an (i+1)^{th} candidate recognition result, n being a positive integer and 1≤i≤n−1, and
a size of an i^{th} extraction box used by an i^{th} neural network layer in the n neural network layers being greater than a size of an (i+1)^{th} extraction box used by the (i+1)^{th} neural network layer.

11. The computing device according to claim 9, wherein each set of candidate recognition results has zero or more recognition boxes, each recognition box having a corresponding location; and
the aggregating the n sets of candidate recognition results to obtain a final recognition result of the head region in the input image comprises:
combining the recognition boxes with corresponding location similarities greater than a preset threshold in the n sets of candidate recognition results into one combined recognition box, and using the combined recognition box as the final recognition result of the head region in the input image.

12. The computing device according to claim 11, wherein each set of recognition boxes has corresponding similarity values, and the combining the recognition results with corresponding location similarities greater than a preset threshold in the n sets of candidate recognition results into one combined recognition box comprises:
acquiring similarity values corresponding to the recognition boxes with the corresponding location similarities greater than the preset threshold;
retaining a recognition box with a largest similarity value and deleting other recognition boxes in the recognition boxes with the corresponding location similarities greater than the preset threshold; and
using the retained recognition box as the final recognition result of the head region in the input image.

13. The computing device according to claim 12, wherein the retaining a recognition box with a largest similarity value and deleting other recognition boxes in the recognition boxes with the corresponding location similarities greater than the preset threshold comprises:
acquiring the recognition box with the largest similarity value in the recognition frames as a first recognition box;
deleting a recognition box with an area that is of a region overlapping with the first recognition box and that is greater than the preset threshold;
acquiring a recognition box with a largest similarity value among first remaining recognition boxes as a second recognition box, the first remaining recognition boxes being the remaining recognition boxes other than the first recognition box and the deleted recognition box of the recognition boxes corresponding to the n sets of candidate recognition results;
deleting a recognition box with an area that is of a region overlapping with the second recognition box and that is greater than the preset threshold;
acquiring a recognition box with a largest similarity value among (j−1)^{th} remaining recognition boxes as a j^{th} recognition box, the (j−1)^{th} remaining recognition boxes being the remaining recognition boxes other than the first recognition box to a (j−1)^{th} recognition box and the deleted recognition box of the recognition boxes corresponding to the n sets of candidate recognition results, and j being a positive integer and 2≤j≤n;
deleting a recognition box with an area that is of a region overlapping with the j^{th} recognition box and that is greater than the preset threshold;
repeating the foregoing operations to acquire k recognition boxes from the recognition boxes corresponding to the n sets of candidate recognition results, k being a positive integer and 2≤k≤n; and
the using the retained recognition box as the final recognition result of the head region in the input image comprising:
using the k recognition boxes as the final recognition result of the head region in the input image.

14. The computing device according to claim 9, wherein the processing the input image using n cascaded neural network layers comprises:
performing local brightening and/or resolution reduction on the input image; and
processing the input image obtained after the local brightening and/or resolution reduction using the n cascaded neural network layers.

15. The computing device according to claim 9, wherein the plurality of operations further comprise:
acquiring a sample image, a head region being marked in the sample image and comprising at least one of a side-view head region, a top-view head region, a rear-view head region, and a covered head region; and
training the n cascaded neural network layers according to the sample image.

16. The computing device according to claim 15, wherein the training the n cascaded neural network layers according to the sample image comprises:
processing the sample image using the n cascaded neural network layers to obtain a training result;
comparing the training result with the marked head region in the sample image to obtain a calculation loss, the calculation loss being used for indicating an error between the training result and the marked head region in the sample image; and
training the n cascaded neural network layers by using an error back propagation algorithm according to the calculation loss corresponding to the sample image.

17. A non-transitory computer readable storage medium, storing at least one instruction, the instruction being loaded and executed by a computing device having one or more processors to perform a plurality of operations including:
acquiring an input image;
processing the input image using n cascaded neural network layers to obtain n sets of candidate recognition results of a head region, each of then neural network layers outputting one respective set of candidate recognition results, the neural network layer being used for recognizing the head region according to a preset extraction box, sizes of extraction boxes used by at least two of the neural network layers being different, and n being a positive integer and n≥2; and
aggregating the n sets of candidate recognition results to obtain a final recognition result of the head region in the input image.

18. The non-transitory computer readable storage medium according to claim 17, wherein the processing the input image using n cascaded neural network layers to obtain n sets of candidate recognition results of a head region comprises:
inputting the input image into a first neural network layer in the n neural network layers to obtain a first-layer feature map and a first set of candidate recognition results; and
inputting an i^{th}-layer feature map into an (i+1)^{th} neural network layer in the n neural network layers to obtain an (i+1)^{th}-layer feature map and an (i+1)^{th} candidate recognition result, n being a positive integer and 1≤i≤n−1, and
a size of an i^{th} extraction box used by an i^{th} neural network layer in the n neural network layers being greater than a size of an (i+1)^{th} extraction box used by the (i+1)^{th} neural network layer.

19. The non-transitory computer readable storage medium according to claim 17, wherein each set of candidate recognition results has zero or more recognition boxes, each recognition box having a corresponding location; and
the aggregating the n sets of candidate recognition results to obtain a final recognition result of the head region in the input image comprises:
combining the recognition boxes with corresponding location similarities greater than a preset threshold in the n sets of candidate recognition results into one combined recognition box, and using the combined recognition box as the final recognition result of the head region in the input image.

20. The non-transitory computer readable storage medium according to claim 17, wherein the processing the input image using n cascaded neural network layers comprises:
performing local brightening and/or resolution reduction on the input image; and
processing the input image obtained after the local brightening and/or resolution reduction using the n cascaded neural network layers.
